(19) United States
(12) Patent Application Publication
(10) Pub. No.: US 2019/0072205 A1
(43) Pub. Date: Mar. 7, 2019

(54) CONTROL VALVE FOR A PROCESS PLANT

(71) Applicant: SAMSON AG, Frankfurt am Main (DE)

(72) Inventors: Hartmut NEUHEUSER, Seck (DE); Gerald JAEHRLING, Langen (DE)

(21) Appl. No.: 16/119,949

(22) Filed: Aug. 31, 2018

(30) Foreign Application Priority Data
Aug. 31, 2017 (DE) 20 2017 105 252.4

(51) Int. Cl. F16K 31/163; F15B 15/28; F16K 1/48

(52) U.S. Cl. CPC F16K 31/1635; F16K 1/482; F15B 15/2815

(57) ABSTRACT

The invention relates to an actuator for a process plant, with a pneumatically operated actuating drive (4), which is connected to a valve housing (8) of a control valve via a yoke (10), and with a drive rod (16), a valve cone (20) actuated by the actuating drive (4) with a valve rod (18), and a rod connector (14), which connects the drive rod (16) and the valve rod (19) to one another for transmitting power, wherein the rod connector (14) is rotationally fixed to the yoke (10), on the one hand. The invention is characterized in that the rod connector (14) is non-rotatably connected to the valve rod (18), on the other hand.

The invention relates to an actuator for process plants.

Disclosed in DE 20 2010 01756 U1 is an actuator for a process plant, comprising an actuating drive, in particular a pneumatically operated actuating drive, that has a drive rod, a valve actuated by the actuating drive and having a valve rod, which valve rod is in particular arranged in the axial extension to the drive rod, a valve cone mounted on the valve rod, and a rod connector which connects the two rods to one another for the transmission of force, in particular of axial translational actuating movements, and is adapted to vary an axial distance between mutually facing ends of the valve rod and the drive rod so as to adjust the axial total length of the two rods. The rod connector has two half shells to be fastened to each other which have two positioning means for a non-positive coupling of the shells at the respective ends, with at least one of the positioning means being adapted to vary the axial fastening position of the shells along one of the rods, preferably the valve rod.

EP 2 647 892 A1 discloses a slide comprising a slide housing, which slide housing has a spindle drive, which spindle drive has, at its one end, a slider wedge for shutting off a pipe, said spindle drive comprising a motor-driven spindle. The spindle is axially slidably connected to an axle via a clutch, the axle having the slider wedge on its end. In the area of the clutch, the spindle drive has a coupling web, which coupling web is slidably guided by at least one column that extends parallel to the spindle drive. The coupling web comprises two web shells which form a bearing bush in the area of the column.

Valve cones serving as control cones are usually not aligned towards the openings of the valve because plural control contours are usually arranged uniformly around the circumference of the cone and the position of the contours relative to the body openings is of little relevance to the control characteristic, or the cones—once adjusted—cannot rotate at low differential pressures and therefore do not require any additional positive-locking anti-rotation device. At higher pressure differences, the position of the valve cone may change during operation. In case of a fixed rod connection between the valve rod and the drive rod, the tendency of the valve cone to rotate would continue into the actuating drive. There is the risk of the entire yoke eventually turning together with the drive, due to the rotation of the valve cone, which rotation may be caused by the fluid flow through the valve. A further disadvantage is that the outflow characteristics of the fluid through the cone orifices will vary, especially in the case of cones with asymmetrically arranged orifices and/or with orifices of different sizes, depending on the rotation of the cone position. Moreover, rotating cones are more susceptible to wear and exhibit poorer internal tightness.

It is the object of the invention to fix a non-symmetrically flow-optimized control cone towards the inlets and outlets of the housing and to prevent rotation of the cone during operation, using as few additional components as possible.

The object is accomplished by the actuator which has a pneumatically operated actuating drive which is connected via a yoke to a valve housing, a drive rod, a valve cone actuated by the actuating drive and having a valve rod and a rod connector which connects the drive rod and the valve rod to one another for power transmission, with the rod connector on the one hand being connected to the yoke in a non-rotatable manner, in that the rod connector is on the other hand non-rotatably connected to the valve rod so as to prevent rotation of the valve cone relative to the yoke. Once the rod connector has been mounted, the valve rod is firmly mounted on the rod connector and the drive rod so that the valve rod cannot rotate relative to the coupling. Because the rod connector serves as part of the anti-rotation device, the valve rod can thus be locked against rotation relative to the yoke by means of only a few additional components.

The arrangement of the actuator according to the invention is considered particularly advantageous if the openings of the valve cone are asymmetrically distributed or of different sizes, because the valve cone can be precisely aligned towards the valve openings in a flow-optimizing manner. The fact that, in the actuator according to the invention, the drive is protected against rotation or a torque on the drive rod is also considered advantageous because the diaphragms or seals are not subjected to any additional loads.

It is considered advantageous for the actuator according to the invention to have the yoke fixed to the valve body by a positive connection, so that the rotational position of the valve body relative to the yoke is fixed. It is also advantageous to protect the yoke from rotation and to create a defined position towards the valve using the anti-rotation device. This also ensures that the entire structure consisting of the valve cone, the valve rod, the drive rod, the actuating drive and the yoke cannot rotate relative to the body.

A mechanical positive connection can serve as a positive connection between the yoke and the valve body, for which purpose a ball/ball receptacle or a pin/pin receptacle or feather keys or elevations and recesses between the yoke and valve body can be used in an advantageous manner.

In the actuator according to the invention, the rod connector may advantageously be formed by two half-shells that are bolted together, and the rod connector may then comprise a first connection device on the drive rod side and a second connection device on the valve rod side, which allows a non-rotational connection of the valve rod and the drive rod to be achieved that is easy to assemble.

The connecting device at the drive end of the drive rod can preferably have a coupling head which is embraced by the half-shells via a corresponding groove bulge, thus connecting the rod connector to the valve rod in a non-rotatable manner. Furthermore, the connecting device at the drive-side end of the drive rod can surround a bushing formed by the half-shells of the rod connector, in which bushing a cylindrical extension on the drive rod is accommodated so as to be rotationally fixed. In both cases, this results in a secure connection of the valve rod to the drive rod.

In an advantageous embodiment, the actuator according to the invention includes a guide device for the anti-rotation connection of the rod connector to the yoke. Over the entire stroke range, the rod connector is slidingly guided in an axially movable manner along the guide device, which prevents the valve rod and thus the valve cone from turning.

The advantage of the above actuator is that the guide device has a guide rail aligned with the yoke in the direction of movement of the valve rod and a guide carriage guided on the guide rail and integrally formed with the rod connector. The guide carriage can have two legs that engage with the guide rail on both sides via sliding layers.

Advantageously, the rod connector of the actuator according to the invention can also have a pointer on the yoke and a marking, thus allowing the stroke of the valve body to be read off.

In the actuator according to the invention, the rod connector may advantageously include a mechanical stroke pick-up device that can be coupled to a positioner or stroke indicator in order to output a control signal proportional to the stroke value.

Additional advantages, features and possible applications of the present invention can be gathered from the description which follows, in which reference is made to the embodiments illustrated in the drawings.

Throughout the description, the claims and the drawings, those terms and associated reference characters are used as are indicated in the List of Reference Characters which follows below. In the drawings

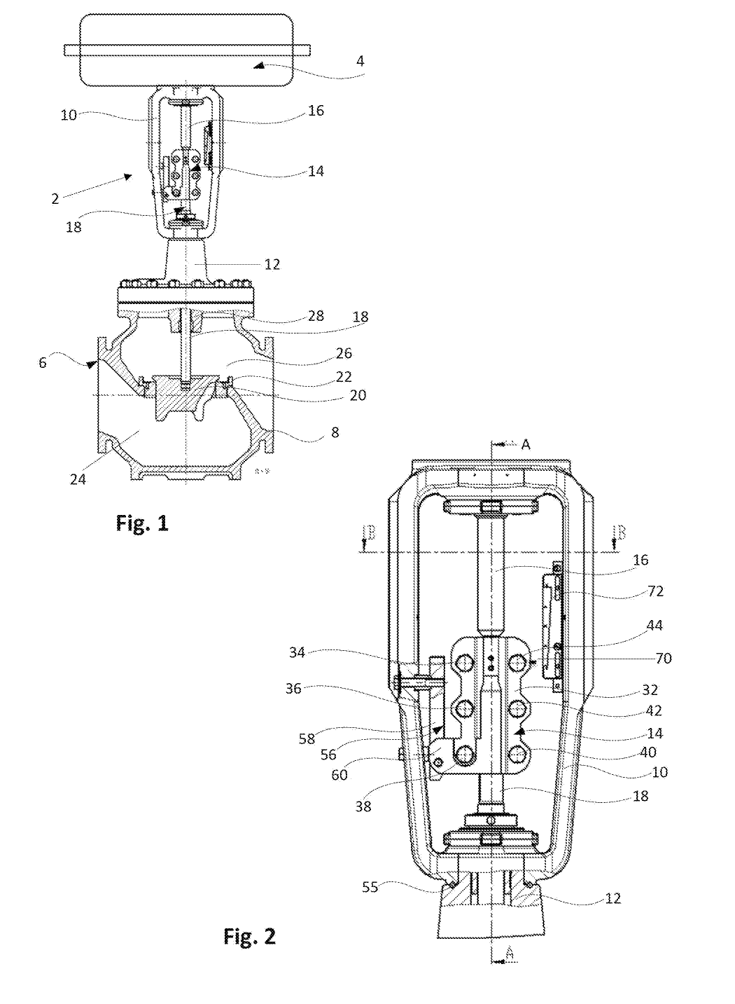

FIG. 1 is a sectional view of an actuator having a rod connector, in accordance with the invention;

FIG. 2 is a lateral view of the part of the actuator that has the rod connector, in accordance with the invention;

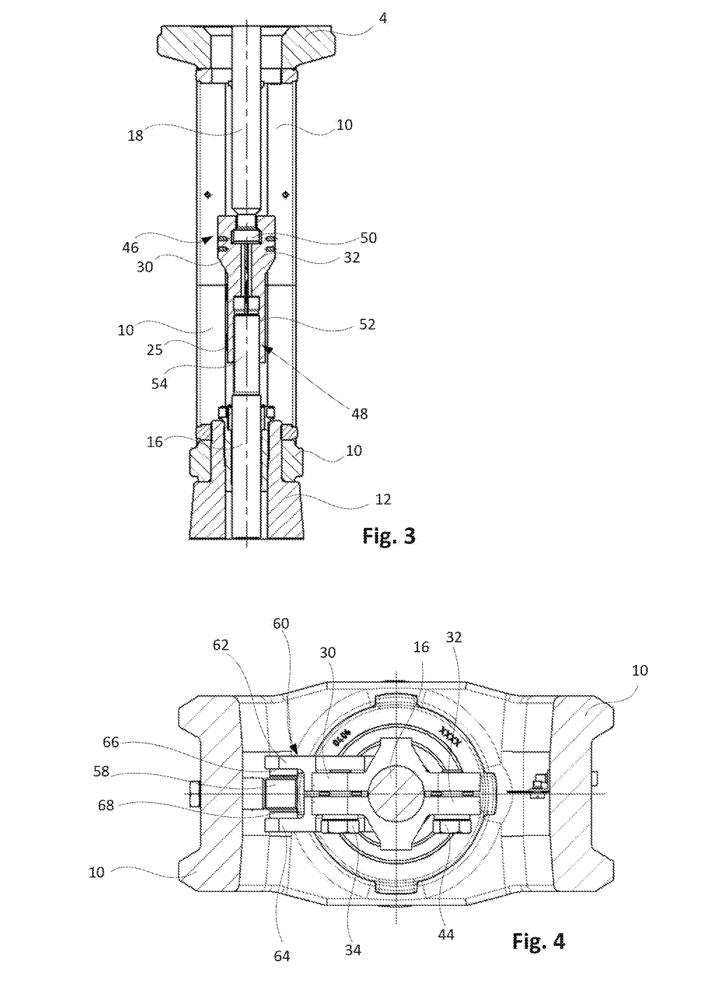

FIG. 3 is a sectional view taken along line A-A of FIG. 2;

FIG. 4 is a sectional view taken along line B-B of FIG. 2.

FIG. 1 is a sectional view of an actuator 2 according to the invention. The actuator 2 essentially comprises a pneumatic actuating drive 4, a control valve body 6 with a valve housing 8, a yoke 10 arranged between the actuating drive 4 and the valve housing 8 or a cover 12 of the valve housing 8 and fixed to the valve housing 8 by positive locking, as well as a rod connector 14 through which the actuating movement is transmitted from the pneumatic actuating drive 4 to the control valve body 6. A drive rod 16 of the actuating drive 4 extends out of the actuating drive 4.

The control valve body 6 is equipped with a valve rod 18 that is axially aligned vertically to the drive rod 16. A valve cone 20 is arranged at the end of the valve rod 18 that faces away from the actuating drive 4. The valve cone 20 is used to open and/or close an opening of a valve seat 22 in order to allow or to block a flow through the control valve body 6 from an inlet area 24 to an outlet area 26.

To guide the valve rod 18, a guide sleeve 28 on the valve seat side and a seal packing (not shown) are provided. To connect the valve-side end of the drive rod 16 and the drive-side end of the valve rod 18, the rod connector 14 is provided which is implemented by two half-shells 30, 32. The two half shells 30, 32 are attached to each other by means of bolts 34, 36, 38, 40, 42, 44.

The rod connector 14, which on the one hand is non-rotatably connected to the yoke 10 and on the other hand is firmly connected to the valve rod 18, has a first connection device 46 on the drive rod side and a second connection device 48 on the valve rod side. The connection device 46 on the drive end of the drive rod 16 comprises a coupling head 50 which the half-shells 30, 32 embrace by means of a corresponding groove bulge, so that the rod connector 14 is non-rotatably fastened to the valve rod 18.

The connection device 48 on the valve rod end of the drive rod 16 comprises a bushing 52 formed by the half shells 30, 32 of the rod connector 14 and a cylindrical extension 54 on the drive rod 16 which is received in the bushing 52 in a rotationally fixed manner.

The positive connection between yoke 10 and valve housing 8 may have a ball/ball receptacle or pin/pin receptacle or feather keys or elevations and depressions between the yoke and the valve housing, with a ball/ball receptacle 55 being shown in the view of FIG. 2.

The non-rotatable connection of the rod connector 14 with the yoke 10 consists of the yoke 10 having a guide device 56 along which the rod connector 14 is slidingly guided in an axially movable manner over the entire stroke range of the valve rod 18. The guide device 56 comprises a guide rail 58 aligned on the yoke 10 in the direction of movement of the valve rod 18 and a guide carriage 60 guided on the guide rail 58 and integrally formed on the rod connector 14. The guide carriage 60 has two legs 62, 64 which engage the guide rail 58 on both sides via sliding layers 66, 68.

The rod connector 14 may have a pointer 70, and a marking 72 may be provided on the yoke 10, so that the stroke of the valve cone 20 can be read off. The rod connector 14 may also have a mechanical stroke pick-up device which can be coupled to a positioner or to a stroke indicator to output a control signal proportional to the stroke value.

The invention is not limited to the embodiment shown. The seal arrangement may for instance be arranged at other locations of actuators, for example between the valve seat and the valve housing.

### LIST OF REFERENCE CHARACTERS

2 actuator

4 actuating drive

6 control valve body

8 valve housing

10 yoke

12 cover

14 rod connector

16 drive rod

18 valve rod

20 valve cone

22 valve seat

24 inlet area

26 outlet area

28 guide sleeve

30, 32 half shells

34-44 bolts

46 drive-side connection device

48 valve-side connection device

50 coupling head

52 bushing

54 shoulder

55 ball/ball holder device

56 guidance device

58 guide rail

60 guide carriage

62, 64 legs

66, 68 sliding layers

70 pointer

72 marking

1. Actuator for a process plant, having a pneumatically operated actuating drive (4) which is connected to a valve housing (8) via a yoke (10) and has a drive rod (16), a valve cone (20) which is actuated by the actuating drive (4) and has a valve rod (18), and a rod connector (14) which connects the drive rod (16) and the valve rod (18) to one another for force transmission, which rod connector (14) is non-rotatably fixed to the yoke (10), on the one hand, characterized in that said rod connector (14) is non-rotatably connected to the valve rod (18), on the other hand.

2. Actuator according to claim 1, characterized in that the yoke (10) is secured to the valve housing (8) by a positive fit.

3. Actuator according to claim 2, characterized in that the positive fit between the yoke (10) and the valve housing (8) has a ball/ball receptacle or pin/pin receptacle or feather keys or elevations and depressions between the yoke (10) and the valve housing (8).

4. Actuator according to claim 1, characterized in that the rod connector (14) is formed by two half-shells (30, 32) which are fastened to one another by bolts (34, 36, 38, 40, 42, 44), and that the rod connector (14) comprises a first connecting device (46) on the drive rod side and a second connecting device (48) on the valve rod side.

5. Actuator according to claim 4, characterized in that the connecting device (46) has a coupling head (50) on the drive end of the drive rod (16), which head (50) is embraced by the half shells (30, 32) via a corresponding groove bulge so that the rod connector (14) is non-rotatably mounted on the valve rod (18).

6. Actuator according to claim 4, characterized in that, on the drive end of the drive rod (16), the connecting device (48) comprises a bushing (52) formed by the half shells (30, 32) of the rod connector (14), in which bushing (52) a cylindrical shoulder (54) on the drive rod (16) is non-rotatably mounted.

7. Actuator according to claim 5, characterized in that, on the drive end of the drive rod (16), the connecting device (48) comprises a bushing (52) formed by the half shells (30, 32) of the rod connector (14), in which bushing (52) a cylindrical shoulder (54) on the drive rod (16) is non-rotatably mounted.

8. Actuator according to claim 1, characterized in that for non-rotatably connecting the rod connector (14) to the yoke (10), the yoke (10) has a guide device (56) along which the rod connector (14) is slidingly guided in an axially movable manner over the entire stroke range.

9. Actuator according to claim 8, characterized in that the guide device (56) has a guide rail (58) aligned on the yoke (10) in the direction of movement of the valve rod (18) and a guide carriage (60) guided on the guide rail (58) and integrally formed on the rod connector (14).

10. Actuator according to claim 9, characterized in that the guide carriage (60) has two legs (62, 64) which engage on both sides on the guide rail (58) via sliding layers (66, 68).

11. Actuator according to claim 1, characterized in that a pointer (70) is provided on the rod connector (14) and a marker (72) is provided on the yoke (10) so that the stroke of the valve body (20) can be read off.

12. Actuator according to claim 1, characterized in that the rod connector (14) comprises a mechanical stroke pick-up device which can be coupled to a positioner or a stroke indicator in order to output a control signal which is proportional to the stroke value.
